(19) United States
(12) Patent Application Publication
(10) Pub. No.: US 2015/0042111 A1
(43) Pub. Date: Feb. 12, 2015

(54) VEHICULAR HANDLE DEVICE

(71) Applicant: Alpha Corporation, Yokohama-shi, Kanagawa (JP)

(72) Inventors: Shinji Ichikawa, Yokohama-shi (JP); Shuichi Kudoh, Yokohama-shi (JP)

(73) Assignee: Alpha Corporation, Yokohama-shi, Kanagawa (JP)

(21) Appl. No.: 14/384,171

(22) PCT Filed: Mar. 26, 2013
(86) PCT No.: PCT/JP2013/058672

§ 371 Date: Sep. 10, 2014

(30) Foreign Application Priority Data
Apr. 10, 2012 (JP) 2012-089398

(51) Int. Cl. E05C 3/14; E05B 7/00

(52) U.S. Cl. CPC E05C 3/14; E05B 7/00
USPC 292/336.3

(57) ABSTRACT

An object of the present invention is to provide a vehicular handle device capable of preventing interference between an inner periphery of a torsion spring and a pivot shaft under operating conditions, thereby preventing abnormal noise from occurring during operation. Provided is a vehicular handle device, including: a handle base 2 fixed to a vehicle and holding an operating handle 1; a turning component 3 attached to the handle base 2 and being turnable between its initial position and actuated position; a torsion spring 5 wound around a spring-wound shaft 4 and configured to bias the turning component 3 to the initial turning position; and a coil restraining portion 7 configured to abut on an outer periphery of a coil portion 6 of the torsion spring 5 thereby to restrain the coil portion 6 from moving in a radial direction.

### TECHNICAL FIELD

The present invention relates to a vehicular handle device.

### BACKGROUND ART

A handle device disclosed in Patent Document 1 has been known as a vehicular handle device including a turning component pivotally supported in a turnably-operable manner on a handle base fixed to a vehicle.

In this conventional example, an operating handle as the turning component is pivotally supported on the handle base in a manner turnable around a pivot shaft. The operating handle is turnable between its initial turning position and turned position and is biased to the initial turning position by a torsion spring wound around the pivot shaft.

### PRIOR ART DOCUMENT

### Patent Document

Patent Document 1: Japanese Patent Application Publication No. 2003-201777

### SUMMARY OF THE INVENTION

### Problems to be Solved by the Invention

However, in the above-mentioned conventional example, when the operating handle is turned to apply a turning force to the torsion spring in a warping direction, forces which cause deformation in a direction of diameter reduction and, in addition, bending of a coil portion or radial displacement between coils are applied to the coil portion of the torsion spring, and thus, an inner periphery of the coil portion may abut on the pivot shaft and hence cause abnormal noise during turning operation, depending on a turning angle, the bending of the coil portion during the turning operation, or clearance between the inner periphery of the coil portion and the pivot shaft.

Also, if an inner diameter of the torsion spring is excessively large with respect to the pivot shaft, the installed position of the torsion spring varies, and loads are consumed by variations in a warping angle of the coil portion and, in addition, the bending of the coil portion, the displacement between the coils, or the like, which in turn leads to a problem; specifically, the torsion spring does not offer its given spring performance.

The present invention has been made in order to eliminate the foregoing drawbacks. An object of the present invention is to provide a vehicular handle device capable of preventing interference between an inner periphery of a torsion spring and a pivot shaft under operating conditions, thereby preventing abnormal noise from occurring during turning operation.

### Means for Solving the Problem

According to the present invention, the above object is attained by providing a vehicular handle device including: a handle base 2 fixed to a vehicle and holding an operating handle 1; a turning component 3 attached to the handle base 2 and being turnable between its initial position and actuated position; a torsion spring 5 wound around a spring-wound shaft 4 and configured to bias the turning component 3 to the initial position; and a coil restraining portion 7 configured to abut on an outer periphery of a coil portion 6 of the torsion spring 5 thereby to restrain the coil portion 6 from moving in a radial direction.

The turning component 3 is attached to the handle base 2 of the vehicular handle device turnably between the initial position and the actuated position, and the torsion spring 5 is wound around the spring-wound shaft 4 in order to bias the turning component 3 to the initial position. The turning component 3 may be the operating handle 1 or may be a component other than the operating handle 1, such as an output lever to be described later.

In the present invention, the torsion spring 5 is configured so that a range of movement of an outer peripheral portion of the coil portion 6 is restrained by the coil restraining portion 7. Thereby, even if the coil portion 6 moves in the radial direction due to the fact that the coil portion 6 is curved, tilted or otherwise deformed, an inner periphery of the coil portion 6 does not abut on the spring-wound shaft 4, and thus, abnormal noise is prevented with reliability from being caused by sliding contact involved in turning of the turning component 3, or solid powder biting into a sliding contact area.

Also, the coil portion 6 is prevented from translating movement or the like, and thus, the spring-wound shaft 4 can be brought into close proximity with an inner diameter of the coil portion 6, and thus, the mounted position of the torsion spring 4 can become stable, so that spring performance close to its designed value can be imparted to the torsion spring 4.

When the turning component 3 is pivotally supported around a pivot shaft, the torsion spring 5 can also use the pivot shaft as the spring-wound shaft 4; however, the spring-wound shaft 4 having the pivot shaft inserted thereinto and passed therethrough, or turnably linked at both ends directly to the handle base 2 may be formed in the turning component 3.

The coil restraining portion 7 can also be formed as a recess portion such that the coil portion 6 is fitted therein substantially halfway around its outer periphery. However, the vehicular handle device may be configured as given below; specifically, the coil restraining portion 7 is formed in a lever shape to be able to abut on a region of the coil portion 6 defined by generating lines at an acute central angle. Thereby, a factor responsible for an obstacle to attachment of the torsion spring is reduced, and thus, a reduction in ease of attachment operation for the torsion spring 5 can be prevented.

Further, the handle device may be configured in such a manner that the spring-wound shaft 4 is formed in a stepped pin shape in which one end portion has a larger diameter than the other end portion.

The torsion spring 5 is used as being locked at one locking leg 5a (or a fixed side) to the handle base 2 and at the other locking leg 5b (or a movable side) to the turning component 3; when a load is applied to the movable end side, a force which causes displacement between the coil portions 6 or the like is developed in any one of the locking legs, depending on the mounted position of the torsion spring 5.

In the present invention in which the spring-wound shaft 4 is formed in the stepped pin shape, the spring-wound shaft 4 may be formed for example as a stepped pin in which the spring-wound shaft 4 has a small diameter on the side on which there is a large amount of radial movement and has a large diameter on the side on which there is a small amount of movement. Thereby, the position of the coil portion 6 can be restrained on the large-diameter side, and thus the torsion spring 5 can be used as a whole in its designed position, so that the installed position of the torsion spring 5 can become stable.

Also, the coil restraining portion 7 can be configured to restrain the coil portion 6 from moving throughout its overall length; however, as mentioned above, radial movements of the coil portion 6 due to its deformation, on both ends, become unequal.

Therefore, the vehicular handle device may be configured so that the coil restraining portion 7 restrains the coil portion 6 from moving between its one end portion and longitudinal intermediate portion. Thereby, a factor responsible for an obstacle to attachment of the torsion spring is reduced, and thus, a reduction in ease of attachment operation for the torsion spring 5 can be prevented.

A range of restraint by the coil restraining portion 7 is determined by experiment or calculation obtaining the end portion of the coil on the side on which the coil has a large amount of radial movement.

In this case, position control of the torsion spring 5 and prevention of abnormal noise generation can be optimally performed by bringing the range of restraint by the coil restraining portion 7 into correspondence with a small-diameter portion 4a of the spring-wound shaft 4.

Also, the diameter of the spring-wound shaft 4 on the possible side on which the coil portion 6 may move may be set small. Thereby, a larger amount of radial movement of the coil portion 6 can be allowed, and thus, radial movement of the coil portion 6 in initial stages of turning is accommodated by clearance formed between the spring-wound shaft 4 and the small-diameter portion 4a, so that movement alone in later stages of turning can be restrained by the coil restraining portion 7. Such a configuration eliminates a need to cause the outer periphery of the coil portion 6 to abut on the coil restraining portion 7 at all times or in early stages of turning operation, and thus enables reducing sliding contact in the outer peripheral portion to a minimum.

### Effect of the Invention

According to the present invention, interference between an inner periphery of a torsion spring and a spring-wound shaft under operating conditions can be prevented, and thus, abnormal noise can be prevented with reliability from occurring during turning operation.

### BRIEF DESCRIPTION OF THE DRAWINGS

FIG. 1 is a view illustrating the present invention, Part (a) is a plan view, and Part (b) is a view taken in a direction of arrow 1B of Part (a).

FIG. 2 is a view illustrating a principal part of the present invention, Part (a) is a view taken in a direction of arrow 2A of Part (b) of FIG. 1, and Part (b) is a cross-sectional view taken along line 2B-2B of Part (a) of FIG. 2.

FIG. 3 is a view illustrating operation of the present invention, Part (a) is a cross-sectional view taken along line 3A-3A of Part (b) of FIG. 2, Part (b) is a cross-sectional view taken along line 3A-3A of Part (b) of FIG. 2 under a condition where an operating handle is turned to its actuated position, Part (c) is a view illustrating a torsion spring, and Part (d) is a view taken in a direction of arrow 3D of Part (c) of FIG. 3.

FIG. 4 is a view illustrating operation of the present invention, Part (a) is a cross-sectional view taken along line 4A-4A of Part (b) of FIG. 2, and Part (b) is a cross-sectional view taken along line 4A-4A of Part (b) of FIG. 2 under a condition where the operating handle is turned to its actuated position.

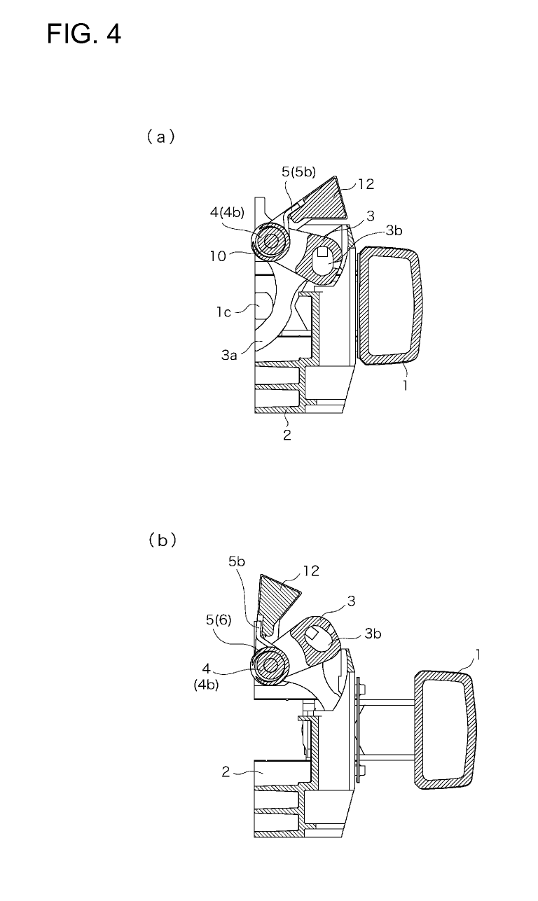

### MODE FOR CARRYING OUT THE INVENTION

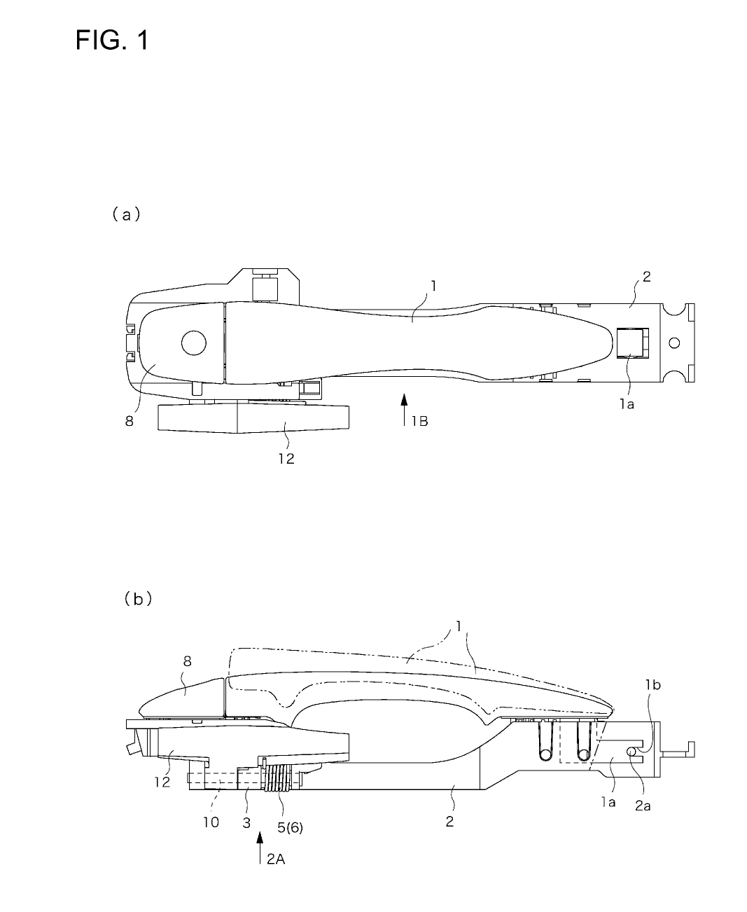

As illustrated in FIG. 1 and the following figures, a handle device includes a handle base 2 fixed to a door panel (not illustrated), and an operating handle 1 linked to the handle base 2.

As illustrated in Part (b) of FIG. 1, the operating handle 1 has a hinged leg 1a in one end portion, and the operating handle 1 is linked to the handle base 2 in such a way as to be turnable around a fitting portion as a center of rotation, by fitting a recess portion 1b of the hinged leg 1a over a hinge protrusion portion 2a formed on the handle base 2. A stopper block 8 is linked to the handle base 2 in order to restrain the operating handle 1 from moving in a direction in which the fitting of the operating handle 1 with the hinge protrusion portion 2a is released.

Mounting of the handle device to a door is accomplished by fixing the handle base 2 along an inner wall of the door panel, then linking the operating handle 1 to the handle base 2 from an outer side of the door, and then linking the stopper block 8 to the handle base 2 from the outer side of the door.

Also, an output lever as a turning component 3 is turnably linked to the handle base 2 around a pivot shaft 10 arranged across hinge protruding pieces 9. The output lever 3 has an input portion 3a and an output portion 3b, the input portion 3a formed in an arm shape is locked to a locking portion 1c formed on one end of the operating handle 1, and the output portion 3b is linked via a cable device or the like to a door lock device 11 arranged in the door.

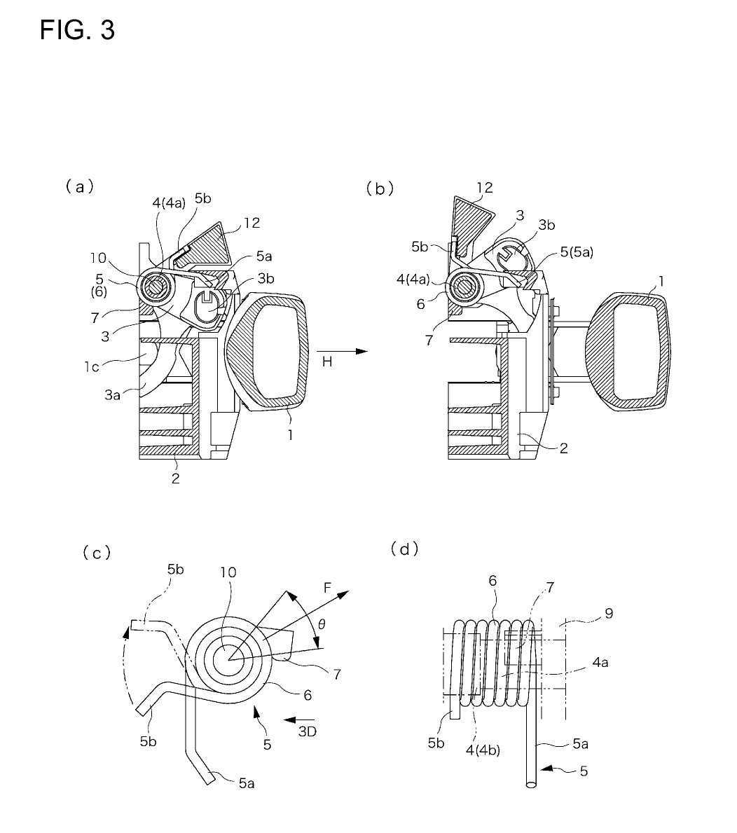

In the above-described configuration, when the operating handle 1 is turned from its initial position illustrated by full lines in Part (b) of FIG. 1 to its turned position illustrated by dash-double dot lines therein, the one end of the operating handle 1 moves in a direction of arrow (H) as illustrated in Parts (a) and (b) of FIG. 3. When the locking portion 1c moves in the direction of arrow (H) as the operating handle 1 moves, the output portion 3b of the output lever 3 turns counterclockwise from its initial position illustrated in Part (a) of FIG. 3 and moves to its actuated position illustrated in Part (b) of FIG. 3 to actuate the door lock device 11.

A torsion spring 5 is wound around the output lever 3 in order to bias the output lever 3 to the initial position. The torsion spring 5 holds the operating handle 1 in the initial position by applying a bias force in a direction in which the locking portion 1c of the operating handle 1 is pressed against the input portion 3a of the output lever 3.

As illustrated in Parts (c) and (d) of FIG. 3, the torsion spring 5 has locking legs 5a, 5b on both ends of a coil portion 6 and is locked at one of the locking legs 5a, 5b as a fixed end to the handle base 2 and at the other thereof as a movable end to a counter weight 12 externally fitted to the output lever 3, and the bias force of the torsion spring 5 is transmitted via the counter weight 12 to the output lever 3. The counter weight 12 is locked to the output lever 3 clockwise in a position illustrated in Parts (a) and (b) of FIG. 3 and is turnable counterclockwise from this position independently of the output lever 3, and the counter weight 12 is provided in order to balance a turning force in a direction in which the door is opened by an inertial force of the operating handle 1 at the time of occurrence of side crash of a vehicle.

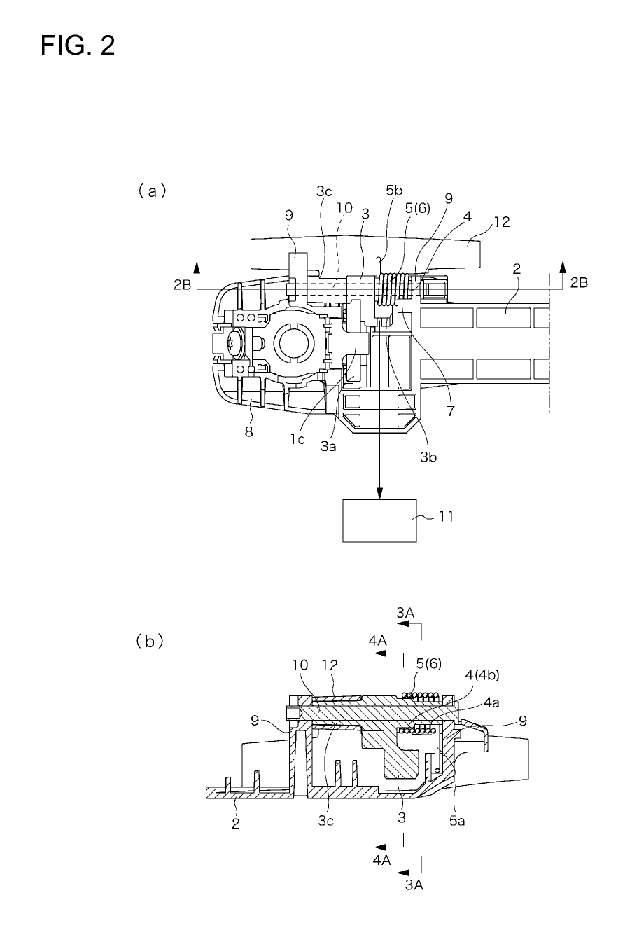

As illustrated in FIG. 2, the pivot shaft 10 pivotally supporting the output lever 3 is attached longitudinally of the handle base 2, and the output lever 3 is held around the pivot shaft 10 by inserting and passing the pivot shaft 10 into and through a cylindrical portion 3c. As illustrated in Part (b) of FIG. 2, the cylindrical portion 3c turnably holds the counter weight 12 in one end portion and has a spring-wound shaft 4 formed in the opposite end portion and having the torsion spring 5 wound therearound. The spring-wound shaft 4 is configured in such a manner that an end portion corresponding to the movable end side has a larger diameter than the other end, and an inner diameter of the torsion spring 5 is formed slightly larger than a large-diameter portion 4b.

Also, the hinge protruding piece 9 is provided with a coil restraining portion 7 protruding therefrom. As illustrated in Part (c) of FIG. 3, the coil restraining portion 7 is arranged at a position to restrain movement by a translating movement force (in a direction of arrow F in Part (c) of FIG. 3) produced in the coil portion 6 when a load is imposed on the locking leg 5a. The coil restraining portion 7 is formed in such a lever shape as to correspond to an outer peripheral region of the coil portion 6 defined by an acute central angle (A), and extends from the hinge protruding piece 9 to an intermediate portion of the spring-wound shaft 4.

Also, a small-diameter portion 4a of the spring-wound shaft 4 mentioned above is arranged in a region on the side on which movement of the coil portion 6 is restrained by the coil restraining portion 7.

In this embodiment, therefore, when the operating handle 1 is turned to turn the output lever 3, the coil portion 6 of the torsion spring 5 moves in a radial direction while making its diameter smaller; however, before an inner periphery of the coil portion 6 abuts on an outer periphery of the spring-wound shaft 4, an outer periphery of the coil portion 6 abuts on the coil restraining portion 7 and thus the coil portion 6 is restrained from moving in the radial direction, so that abnormal noise is prevented from being caused by sliding contact of the inner periphery.

### EXPLANATION OF REFERENCE NUMERALS

1 Operating Handle
2 Handle Base
3 Turning Component
4 Spring-Wound Shaft
5 Torsion Spring
6 Coil Portion
7 Coil Restraining Portion

1. A vehicular handle device, comprising:
a handle base fixed to a vehicle and holding an operating handle;
a turning component attached to the handle base and being turnable between its initial position and actuated position;
a torsion spring wound around a spring-wound shaft and configured to bias the turning component to the initial position; and
a coil restraining portion configured to abut on an outer periphery of a coil portion of the torsion spring thereby to restrain the coil portion from moving in a radial direction.

2. The vehicular handle device according to claim 1, wherein the torsion spring is wound around the spring-wound shaft formed in the turning component.

3. The vehicular handle device according to claim 1, wherein the coil restraining portion is formed in a lever shape to be able to abut on a region of the coil portion defined by generating lines at an acute central angle.

4. The vehicular handle device according to claim 1, wherein the spring-wound shaft is formed in a stepped pin shape in which one end portion has a larger diameter than the other end portion.

5. The vehicular handle device according to claim 1, wherein the coil restraining portion is arranged between one end portion and a longitudinal intermediate portion of the coil portion.

6. The vehicular handle device according to claim 4, wherein the coil restraining portion is arranged between a small-diameter side end portion and an intermediate portion of the spring-wound shaft.
